(19) United States
(12) Patent Application Publication
(10) Pub. No.: US 2016/0036972 A1
(43) Pub. Date: Feb. 4, 2016

(54) System and Method for Addressing Communication Issues for Contact Center Service Quality

(71) Applicant: Genesys Telecommunications Laboratories, Inc., Daly City, CA (US)

(72) Inventors: Herbert Willi Artur Ristock, Walnut Creek, CA (US); Yochai Konig, San Francisco, CA (US); Vyacheslav Zhakov, Burlingame, CA (US); Vyacheslav Sayko, Walnut Creek, CA (US); Eric Tamblyn, Murphy, TX (US)

(21) Appl. No.: 14/445,629

(22) Filed: Jul. 29, 2014

(51) Int. Cl. H04M 3/51; H04M 3/22

(52) U.S. Cl. CPC H04M 3/51; H04M 3/2227; H04M 3/2218

(57) ABSTRACT

A system and method include a processor and a memory, where the memory stores instructions, which when executed by the processor, causes the processor to determine whether a session is hard-to-understand. When the session is hard-to-understand the processor provides an adjustment for the session.

### CROSS-REFERENCE TO RELATED APPLICATION

This application is related to and incorporates by reference in its entirety application Ser. No. ______ (attorney docket number 13058 (GEN01-002-US)) entitled “System and Method for Addressing Hard-to-Understand for Contact Center Service Quality”, filed the same day as this application.

### BACKGROUND

Contact centers may be used by an organization to communicate in an efficient and systematic manner with outside parties. Such contact centers may for example have large numbers of agents staffing telephones and interacting with outside parties and with each other. The contact centers can include an interactive voice response (IVR) system to handle calls, record messages and/or place calls with agents at the contact center.

### BRIEF DESCRIPTION OF THE DRAWINGS

In association with the following detailed description, reference is made to the accompanying drawings, where like numerals in different figures can refer to the same element.

FIG. 1 is a schematic block diagram of an exemplary system supporting a contact center.

FIG. 2 is a block diagram of an exemplary system associated with the recognition server for capturing and analyzing data.

FIG. 3 is a table illustrating an exemplary relation between MOS values, R-values and user satisfaction.

FIG. 4 is a block diagram of exemplary categorization of customer calls, e.g., based on determined phrases.

FIG. 5 is a flow chart of an exemplary logic of the system to determine, analyze and address hard-to-understand communications, e.g., in the context of a contact center.

FIG. 6 is a block diagram of an exemplary computing device.

FIG. 7 is a block diagram of an exemplary computing device.

FIG. 8 is a block diagram of an exemplary computing device.

FIG. 9 is a block diagram of an exemplary computing device.

FIG. 10 is a block diagram of an exemplary network environment including several computing devices.

### DETAILED DESCRIPTION

Systems and methods can provide for determining and adjusting to hard-to-understand sessions, e.g., for improving service quality in the contact center setting. In one example, a phone conversation with bad transmission quality can create stress to a customer and/or agent since the brain tries to fill the missing gaps, even if the customer and agent do not realize it. This can lead to mental exhaustion and a negative emotion. There is increasing interference in the world due to wide-spread use of radio signals, which often decreases a quality of mobile telephony. Internet and landline connections can be affected as well. Additionally or alternatively, there can be language barriers when customer and agents communicate, e.g., in terms of vocabulary and regional accents. Additionally or alternatively, the systems and methods can also identify a helpfulness of the agent to the customer such as an agent understands the customer's issue clearly and adjusts accordingly. The systems and methods address different scenarios in the context of hard-to-understand, e.g., media related issues regarding voice and text quality, and content related scenarios.

For the different scenarios, the communication peers may consciously or unconsciously perceive that there are issues. For example, even when the callers can filter out distractive noise and fill in gaps without callers noticing, their exhaustive brain's work can gradually make them unhappy and result in bad experience. The systems and methods can determine and address explicitly perceived communication issues, e.g., low experience scores and/or explicit negative phrases or words used during the conversation. The systems and methods can also determine and address unconsciously perceived issues, e.g., by monitoring a quality of the communication lines, monitoring phrases used during a conversation, etc.

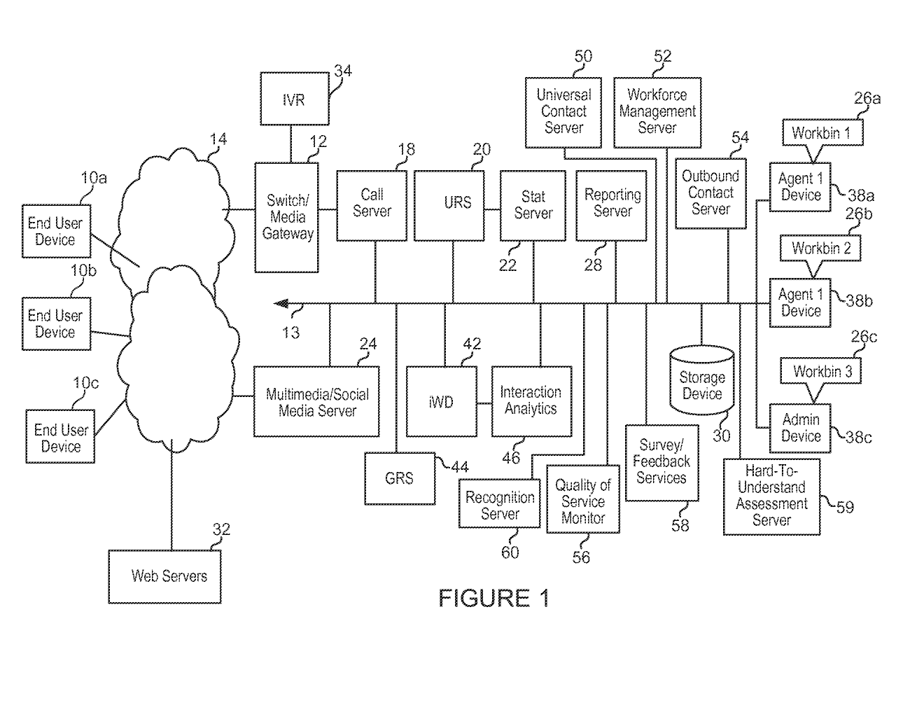

FIG. 1 is a schematic block diagram of an exemplary system, e.g., a system supporting a contact center. The system can be configured to distribute information and task assignments related to interactions with end users (also referred to as customers), to employees of an enterprise, e.g., customer care agents. These task assignments are also referred to herein as work items. The contact center may be an in-house facility of the enterprise and may serve the enterprise in performing the functions of sales and service relative to the products and services available through the enterprise. In another exemplary embodiment, the contact center may be a third-party service provider. Sometimes a quality of the communication lines between the customers and the agents can be poor, even if imperceptibly so. A risk of a low quality voice connection for home agents may be even higher than for agents that work from the contact center. Additionally, knowledge workers who are experts in the enterprise but not full-time agents may answer customer calls with their mobile phone, which can exhibit poorer quality than landlines for example.

The contact center infrastructure may be hosted in equipment dedicated to the enterprise or third-party service provider, and/or hosted in a remote computing environment such as, for example, a private or public cloud environment with infrastructure for supporting multiple contact centers for multiple enterprises. The contact center can include resources (e.g. personnel, computers, and telecommunication equipment) to enable delivery of services via telephone or other communication mechanisms. Such services may vary depending on the type of contact center, and may range from customer service to help desk, emergency response, telemarketing, order taking, and the like. These are some exemplary contexts for the hard-to-understand sessions.

Customers, potential customers, or other end users desiring to receive services from the contact center may initiate inbound calls to the contact center and/or receive outbound calls via their end user devices 10a-10c (collectively referenced as 10). The end user devices 10 may be a communication device, for example, a telephone, wireless phone, smart phone, personal computer, electronic tablet, and/or the like. The mechanisms of contact, and the corresponding user devices 10, need not be limited to real-time voice communications as in a traditional telephone call, but may be non-voice communications including text, video, and the like, and may include email or other non-real-time means of communication. This generalized form of a contact between an end user and the contact center may include methods of communication other than voice, and an endpoint other than a telephone, e.g. interactions.

Inbound and outbound interactions from and to the end user devices 10 may traverse a telephone, cellular, and/or data communication network 14 depending on the type of device that is being used. For example, the communications network 14 may include a private or public switched telephone network (PSTN), local area network (LAN), private wide area network (WAN), and/or public wide area network such as, for example, the Internet. The communications network 14 may also include a wireless carrier network including a code division multiple access (CDMA) network, global system for mobile communications (GSM) network, and/or any 3G, 4G, LTE, etc. network.

The contact center can also include an outbound contact server 54 to perform outbound functions, e.g., in which contact center agents make outbound calls to customers on behalf of a business or client. Calls made from the contact center can include telemarketing, sales or fund-raising calls, as well as calls for contact list updating, surveys or verification services. The systems and methods described herein can be used for both inbound and outbound communications, e.g., to determine if hard-to-understand conditions of the communications exist.

In general, the contact center includes a switch/media gateway 12 coupled to the communications network 14 for receiving and transmitting interactions and/or data between end users and the contact center. The switch/media gateway 12 may include a telephony switch configured to function as a central switch for agent level routing within the center. In this regard, the switch/media gateway 12 may include an automatic interaction distributor, a private branch exchange (PBX), an IP-based software switch, and/or any other switch configured to receive Internet-sourced interactions and/or telephone network-sourced interactions. The switch can be coupled to a call server 18 which may, for example, serve as an adapter or interface between the switch/media gateway 12 and the remainder of the routing, monitoring, and other interaction-handling systems of the contact center. The call server 18 can connect to other elements, e.g., described herein, via a communication/message bus 13.

The contact center may also include a multimedia/social media server 24 connected with the communication/message bus 13. The multimedia/social media server 24 may also be referred to as an interaction server, for engaging in media interactions other than voice interactions with the end user devices 10 and/or web servers 32. The media interactions may be related, for example, to email, chat, text-messaging, web, social media, and the like. The web servers 32 may include, for example, social interaction site hosts for a variety of known social interaction sites to which an end user may subscribe, such as, for example, FACEBOOK™ TWITTER™, and the like. The web servers may also provide web pages for the enterprise that is being supported by the contact center. End users may browse the web pages and get information about the enterprise's products and services. The web pages may also provide a mechanism for contacting the contact center, via, for example, web chat, voice call, email, web real time communication (WebRTC), or the like.

The switch can be coupled to an interactive voice response (IVR) server 34. The IVR server 34 is configured, for example, with an IVR script for querying customers on their needs. For example, a contact center for a bank may tell callers, via the IVR script, to “press 1” if they wish to get an account balance. If this is the case, through continued interaction with the IVR, customers may complete service without needing to speak with an agent.

If the interaction is to be routed to an agent, the interaction is forwarded to the call server 18 which interacts with a routing server, referred to as a Universal Routing Server (URS) 20, for finding the most appropriate agent for processing the interaction. Additionally or alternatively, the URS 20 can handle routing, orchestration and conversation management, among other things. The call server 18 may be configured to process PSTN calls, VoIP calls, and the like. For example, the call server 18 may include a session initiation protocol (SIP) server for processing SIP calls. The call server 18 may include a telephony server (T-server).

In one example, while an agent is being located and until such agent becomes available, the call server may place the interaction in an interaction queue. The interaction queue may be implemented via any data structure, such as, for example, a linked list, array, and/or the like. The data structure may be maintained, for example, in buffer memory provided by the call server 18.

Once an appropriate agent is located and available to handle a call, the call is removed from the call queue and transferred to the corresponding agent device 38a-38b. Collected information about the caller and/or the caller's historical information may also be provided to the agent device for aiding the agent in better servicing the call. The information may also be provided to a stakeholder device 38c for monitoring and training purposes. A stakeholder may be a contact center manager or a supervisor of one or more agents. Stakeholders need not be contact center employees; a product manager employed by the same enterprise, or by another enterprise supported by the contact center, may for example be a stakeholder. The agent/stakeholder device 38a-c may include a telephone adapted for regular telephone calls, VoIP calls, and the like. The agent and stakeholder devices 38a-c may also include a computer for communicating with one or more servers of the contact center and performing data processing associated with contact center operations.

The selection of an appropriate agent for routing an inbound interaction (e.g. a telephony call or other multimedia interaction) may be based, for example, on a routing strategy employed by the routing server 20, and further based on information about agent availability, skills, agent location, and other routing parameters provided, for example, by a statistics (stat) server 22. For example, the stat server 22 may accumulate data about places, agents, and place/agent groups, convert the data into statistically useful information, and pass the calculations to other software applications. The stat server 22 may provide information to the routing server about agents' capabilities in terms of interactions they are handling, the media type of an interaction, and so on.

An exemplary routing strategy employed by the routing server 20 may be that if a particular agent, agent group, or department is requested, the interaction is routed to the requested agent, agent group, or department as soon the requested entity becomes available. If a particular agent has not been requested, the interaction may be routed to agents with the requested skill as soon as those agents become available. If a particular agent group or department has not been requested, the interaction is removed from the routing server queue and routed to an agent group or department handling back-office work. The interaction may be routed directly to agents for immediate processing in some instances. The interaction may be placed into a queue, or for deferred media, the interaction may be placed in a workbin 26a-c, etc. associated with a back-office agent group or department. The workbin 26a-c can include various types of workbins, including a personal agent level workbin, an agent group workbin, an administrative workbin, etc. In this regard, the routing server 20 may be enhanced with functionality for managing back-office/offline activities that are assigned to enterprise employees. Such activities may include, for example, responding to emails and letters, attending training seminars, or performing any other activity (whether related to the contact center or not) that does not entail synchronous, real-time communication with end users. For example, a non-contact center activity that may be routed to a knowledge worker may be to fill out forms for the enterprise, process claims, and the like.

Once a work item is assigned to an agent, the work item may appear in the agent's workbin 26a-26b (collectively referenced as 26) as a work item to be completed by the agent or the work item may be immediately processed by the agent, e.g., similar to voice calls. The agent's workbin may be implemented via any data structure, such as, for example, a linked list, array, and/or the like. The workbin may be maintained, for example, in buffer memory of each agent's computer device and/or maintained on a server to allow for work item reassignments to other agents. A stakeholder device 38c may also have an associated workbin 26c storing work items for which the stakeholder is responsible. Work items may be assigned to various targets, including, as described above, agents and stakeholders, including other persons associated with an enterprise, and including non-human targets such as a servers or computing devices. For example, the assignment of a work item to a target may have the effect of activating a particular email, or a voice response announcing, “You are complaining about a slow internet connection. We are experiencing a problem in your area and are working to resolve it.”

The multimedia/social media server 24 may also be configured to provide, to an end user, a mobile application for downloading onto the end user device 10. The mobile application may provide user configurable settings that indicate, for example, whether the user is available, not available, or availability is unknown, for purposes of being contacted by a contact center agent. The multimedia/social media server 24 may also monitor the status settings.

The contact center may also include a reporting server 28 configured to generate reports from data aggregated by the stat server 22. Other sources for reporting include an interaction concentrator (ICON) collecting atomic events from various media servers and composing call detail record (CDR) type records. These data are read by an extract, transform and load ETL tool 220 of the mining system 60, and into a consolidated data source for business analytics and data-mining, e.g., the Genesys Info Mart (GIM) by Genesys Telecommunications Laboratories, Inc., which serves a business intelligence (BI) application. Such reports may include near real-time reports or historical reports concerning the state of resources, such as, for example, average waiting time, abandonment rate, agent occupancy, and the like. The reports may be generated automatically or in response to specific requests from a requestor, e.g. agent/stakeholder, contact center application, and/or the like.

An interaction analytics server 46 may be used to monitor the interactions in the contact center and analyze all or some of them to identify or quantify certain characteristics of the interaction. These characteristics may include topics, sentiment, satisfaction, or business outcome. An intelligent workload distribution server (iWD server) may be used to create work items; the iWD server may employ a rules system (GRS) 44, which may be a separate entity, or which may be an element of the iWD server. A work item may be more effective than, e.g., an email request, in that the system may assign a due date, monitor progress, and escalate the work item to a supervisor if it is not completed. The iWD server may prioritize a work item and specify characteristics, such as particular skills, needed to handle the work item. The work item may then be sent to another server, such as a routing server 20, which, using information provided by a stat server 22, may identify a particular agent with the specified characteristics, e.g., qualified to handle the work item, and assign the work item to that agent. The GRS 44 can also be used by other services, e.g., orchestration or multi-media (reprioritization).

The interaction analytics server 46 can also use rules (GRS) directly rather than through the iWD server. The interaction analytics server 46 can trigger actions, such as notifying agents, supervisors and customers, and can perform speech analytics and actionable sentiment analysis, e.g., for determining hard-to-understand communications. Findings can be stored in a universal contact server (UCS) 50 for follow-up analysis, e.g. correlation with survey. The contact center can also include a mass storage device 30 for storing data related to contact center operations such as, for example, information related to agents, customers, customer interactions, and the like. The mass storage device may take the form of a hard disk or disk array.

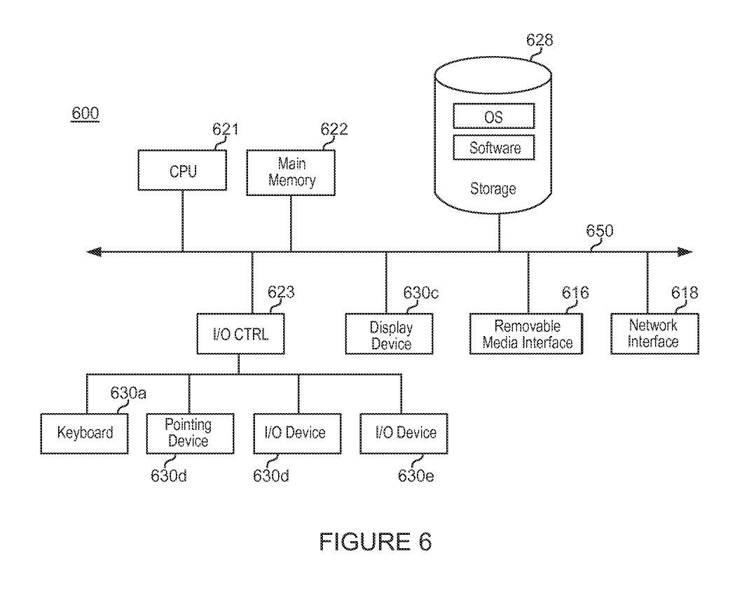

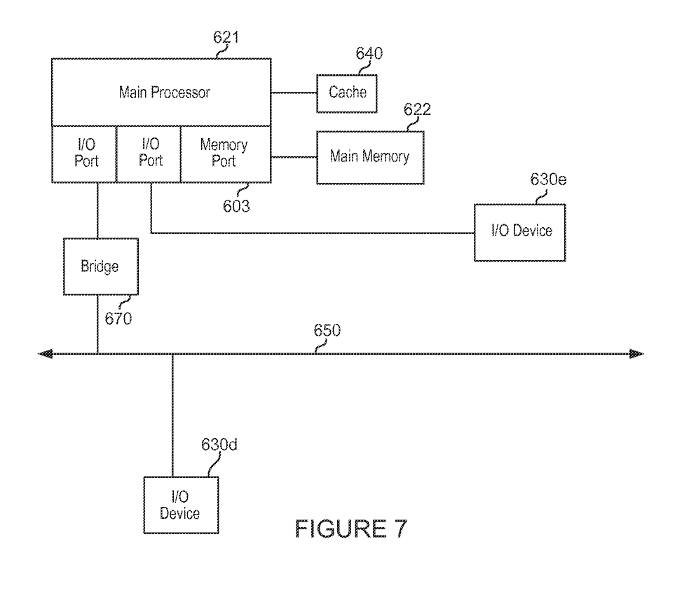

The various servers in the contact center may be a process or thread, running on one or more processors, in one or more computing devices 600 (e.g., FIG. 6, FIG. 7), executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a computing device may be implemented via firmware (e.g. an application-specific integrated circuit), hardware, or a combination of software, firmware, and hardware. The functionality of various computing devices may be combined or integrated into a single computing device, or the functionality of a particular computing device may be distributed across one or more other computing devices. A server may be a software module, which may also simply be referred to as a module. The set of modules in the contact center may include servers, and other modules.

Other contact center elements that can be used for determining, analyzing and addressing hard-to-understand communication conditions, e.g., in the contact center or other environment, include a workforce management server 52, a quality of service monitor 56, survey feedback services 58, hard-to-understand assessment server 59 and a recognition server 60.

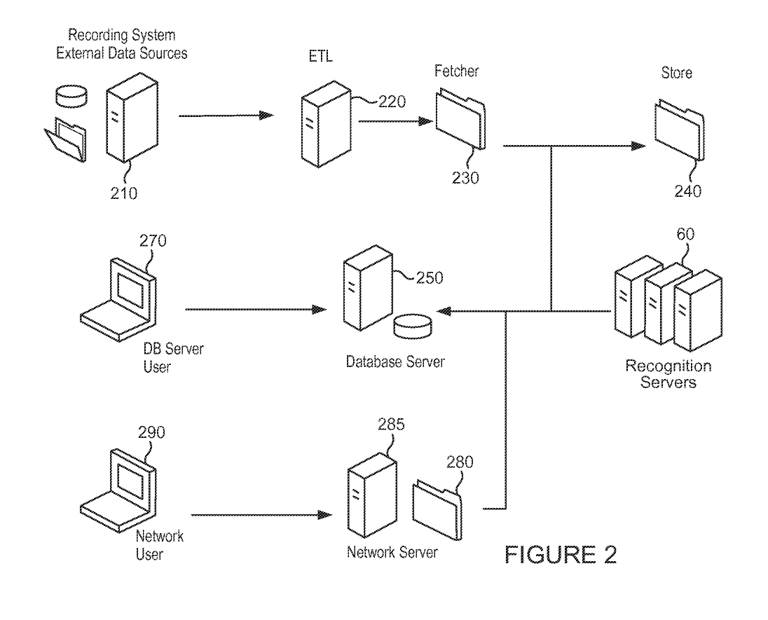

FIG. 2 is a block diagram of an exemplary system associated with the recognition server 60, e.g., for capturing and analyzing audio and metadata, e.g., to determine hard-to-understand sessions. The data mining system 60 can provide for real-time detection of hard-to-understand, e.g., for being able to trigger corrective actions, and/or for non-real time scenarios, e.g., checking whether negative survey responses correlate with hard-to-understand sessions.

For purposes of explanation, the example is a customer interacting with a contact center via a telephone, but other implementations may use the systems and methods. A recording system 210 can record interactions between the customer and the contact center, including live voice calls, voicemails, email, texts, scanned copies of letters, etc. The ETL tool 220 can extract varying types of call and other interaction data from the recording system 210, prepare files and corresponding metadata for processing, and load the files for storage in an input folder. The results can be uniformly stored as an audio file and an xml file. A fetcher task 230 can move the audio files from the input folder to a store folder 240 and write the metadata to a database server 250. One or more recognition servers 60 includes a recognizer task to read audio files from the store folder 240 and create a compressed version of the audio file in the store folder 240.

The recognition servers 60 can identify data that indicates that customer is having or had a poor response to the interaction with the contact center. When the contact center notices a customer's poor response to the interaction with the contact center, in one instance the poor response can imply that the agent is doing a bad job or the IVR script is composed poorly.

Referring also to FIG. 1, another potential root cause of the poor response can be a bad connection between the contact center and customer, the connection including high jitter, packet loss, latency, etc. A network probe system including an interface to the hard-to-understand assessment server 59 can be used to detect and measure the bad connections. The bad connection may cause the customer to have a hard time communicating with the contact center, and vice versa, thereby making the experience more stressful and less enjoyable. Communication issues can occur when the customer interacts with the IVR 34, a live agent, etc. Even poor music quality while the customer is on hold may affect the customer's experience with the contact center. In one example, the customer experience data can be determined by the recognition servers 60.

The recognition server's recognizer task can write recognition results and a categorizer task can write category results to the to the database server 250. A computer 270 can make updates or changes to the recognition and category results. An index task writer can write recognition results, category results and metadata to an index folder 280 on a network server 285, e.g., web server. A computer 290 of the contact center agent can access search, reports, dashboards, etc., to view customer experience data. For example, a contact center agent can access the data via the computer 290. Changes to the contact center personal, equipment, networks, etc. can be made in response to the customer experience data, e.g., pre-connection with the agent, during the call with the agent and/or after the call.

For example, during a customer self-help with the IVR 34, e.g., for high background noise the system can suggest to the customer to change his location, for a poor mean opinion score (MOS) the system can suggest to customer to call again using different phone, the system can ask the customer if he prefers a call back at a specified time and/or suggest to the customer to use non-voice self-help option. During a customer-agent call, for a poor MOS the system can suggest switching to a text chat communication, suggest scheduling another call and/or co-browse options since speech analytics performance can improve when visual information is added to the conversation. Adding video, e.g., to voice can also help address hard-to-understand scenarios which are not caused by poor network connection, but, e.g. pronunciation. The video can also help in case of background noise.

For agent communication issues, the system can alert a supervisor to join the call if available and/or for a severe dissatisfaction level the system can suggest transferring the call to another agent. For customer communication issues, the system can ask if the customer prefer to switch to an agent speaking a different language, and/or different education level of language, if available and/or via a pop-up message to the agent (Agent Assist), instruct the agent to repeat the important facts slowly and clearly and make sure that the customer understands them. As used herein, alternative to suggesting a video chat, browse option, transfer to a supervisor, etc. the actions can be initiated automatically by the system.

Post-call, for agent issues, e.g., including technical QoS and content related issues, if an agent has several hard-to-understand call sessions above a certain threshold then the communication channels can be checked, a coaching/training session can be scheduled and/or the agent pulled off the calls. Agents and/or customers can be rated based on the communications and the information stored with the metadata for using to more accurately connect customers to agents on future calls. In other examples, from the metadata it may be determined that the agent scores low for harder to understand for particular days of the week, determined topics, for customers initiating calls from identified parts of the world, etc. and therefore the agent is not worked on those days. The metadata collected and the actions taken can be implementation dependent. Poor connection issues may not be counted against the agent, for example, but a home agent with consistently poor technical QoS or MOS can be removed from service until the connection problem is fixed.

In addition to MOS, the system can consider other measures of a quality of the communication, e.g., the hard-to-understand condition can be also checked and taken into account when triggering follow-up actions regarding net promoter scores (NPS). For example, after the call the customer can be asked how likely it is that they would recommend the company to a friend or colleague to determine the NPS. For severe agent communication issues, the system can follow-up with the customer via out bound message and suggest another call with supervisor or highly skilled agent, or the system can automatically make that call. Calls with low average MOS score indicating a poor telecommunication system performance during the call may not be utilized against the agent during quality management processes.

Another agent characteristic is the agent's ability to adapt to the customer questions. One measure of the ability to adapt is the richness of language used by the agent. One measure of the richness is perplexity which is based on established information theoretic principles and measures the difficulty of the task. The perplexity of the agent speech can correlate with less predictability and less scripted conversation. Therefore, the language skill levels of agents can be considered. The customers' language skill levels can also be assessed because if a customer cannot fully understand the agent the same effect of hard-to-understand may occur. Voice recognition can help to determine a customers' language skills. In one example, customers with poor language skills can be connected to agents with cleaner pronunciation. In agent low perplexity situations, the agent can be coached to be more flexible. For customer communication issues, the system can follow with outbound message to memorialize the call details in writing.

Therefore, the call interaction data can be used to detect customers' emotions and communication issues and corrective actions can be triggered by the contact center agent or automatically by the systems and method, or both. Both the customer and the contact center agent can be exposed to the same communication conditions, e.g., a poor quality connections. The computer 290, in one example agent devices 38a-38b or admin device 38c, can display the conditions to the agent. For example, the computer 290 can display the MOS value of the quality of the network because the agent may not consciously notice the noise on the network. In one example, the connection can be terminated and redialed based on the MOS value and possible other factors, e.g., taking into account the applied coder/decoders (codecs). In another example, the customer can determine to adjust their communication mode if they are made aware of the situation. For background, channel noise or language issues, the call can be switched to chat or video, etc., as described.

As used herein, the systems and methods can provide suggestions in contexts other than voice calls. For example, in the context of chat and texts, the system can suggest a call or video call when a hard-to-understand session is detected.

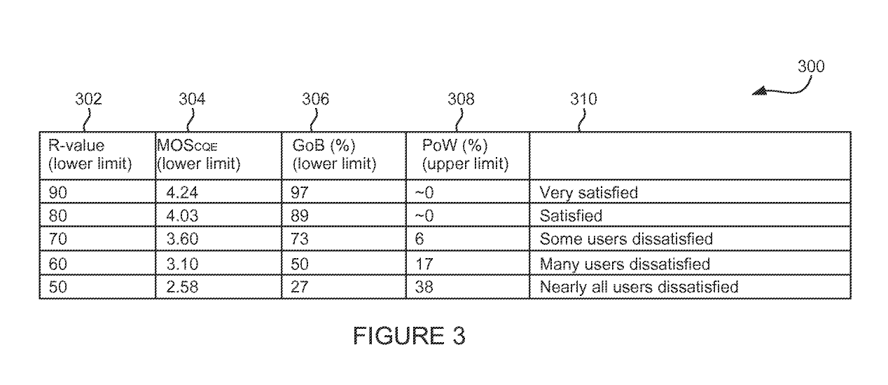

FIG. 3 is a table 300 illustrating an exemplary relation between R-values (transmission rating factor) 302, MOS values 304, GoB (percentage good or better) 306, PoW (percentage poor or worse) 308 and user satisfaction 310, e.g., based on a G.107 international telecommunication union (ITU) scale. The hard-to-understand assessment server 59 can extract features and measurements from either a self-help call, e.g., with IVR 34, or with a customer-agent call. The MOS value 304 includes an overall noise estimation, e.g., a measurement of the overall noise level of the call. In one implementation, a call with MOS value below 3.6 can be considered a hard-to-understand session, whether explicitly identified by the caller as such or not. Multiple levels of severity of user dissatisfaction can exist, e.g., 3.1 that many users are dissatisfied, and 2.58 that nearly all users are dissatisfied.

In some implementations, the background noise can be estimated separately from the overall noise represented by the MOS value 304. For example, an application installed on a mobile phone can estimate the background noise during pauses in a conversation and broadcast the estimated noise back to the hard-to-understand assessment server 59 or other location. If the estimated background noise is above a determined level, the customer experience with the IVR 35 or live agent can be adversely affected, even if the customer if not conscious of the background noise. Background noise can include traffic noise, street noise, airport noise, babies crying, dogs barking, and other noises in the environment. During a call with the agent or even pre-call when the customer is interacting with the IVR 34, the system can prompt the customer to move away from the background noise. Additionally or alternatively, if a problem with background noise is detected during the call, the call can be switched to chat, video, etc. to help reduce the effects of hard-to-understand sessions due to the background noise.

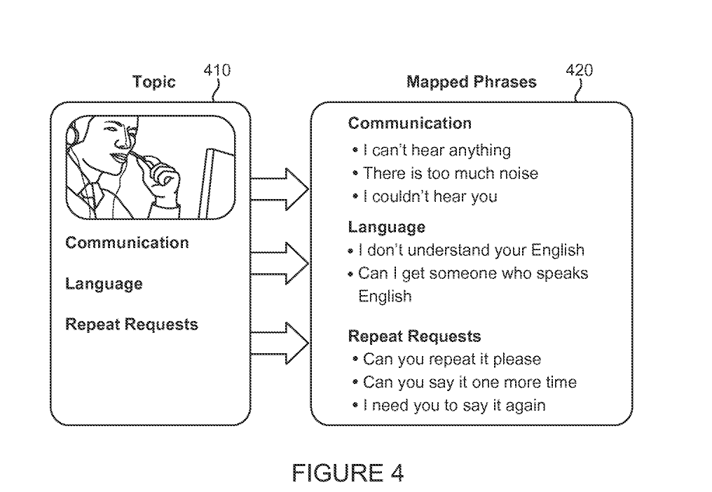

FIG. 4 is a block diagram of exemplary categorization of customer calls, e.g., based on determined phrases. The customer may verbalize communication issues with the IVR 34 or agent. Speech analytics can infer if the customer is complaining about communication issues, e.g., by looking for spoken phrases. The phrases can be categorized into topics 410, e.g., by communication, language, repeat requests, etc. The categories can be determined as union of mapped phrases 420. For example, if the caller states “I can't hear anything” the call can be classified as a communication issue. A call can be classified as a repeat requests if the customer utters phrases such as “Can you repeat it please?” or “I need you to say it again”. Similarly, the agent can express his inability to understand the customer speech. Additionally or alternatively, the system can determine a helpfulness or lack of helpfulness of the agent using speech analytics with regard to whether or not the agent understands the customer's issue clearly and/or has the experience level to be able to address the issue. A speech analytics system can be used to perform phrase recognition to detect such phrases in a phone conversation. An exemplary speech recognition system is described in U.S. Pat. No. 7,487,094 B1, “System and Method of Call Classification with Context Modeling based on Composite Words”, Konig et.al.

Automatic Speech Recognition (ASR) systems, and LVCSR (Large Vocabulary Continuous Speech Recognition) transcription (speech-to-text) engines can output a sequence of recognized words and for each word an associated confidence measure. The average confidence can be served as a measure of understandability of the spoken words in the conversation. The measure can be computed for the agent side and for customer side separately.

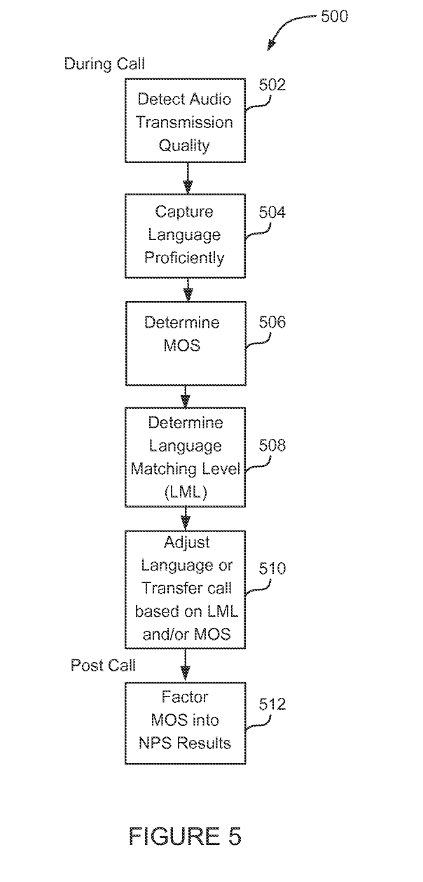

FIG. 5 is a flow chart of an exemplary logic 500 of the system to determine, analyze and address hard-to-understand sessions, e.g., in the context of a contact center. While audio communication which is hard-to-understand can negatively impact the customer experience during a contact center call and lead to dissatisfaction, e.g., customer's bad rating in a survey or frustration observed during call monitoring/recording, the service itself might have been actually good. A conclusion from customer's negative feedback need not indicate that the agent did not do a good job and needs training on the subject, needs transferring to a different job, needs his proficiency downgraded, etc. The customer's dissatisfaction may have been mainly caused by hard-to-understand conditions which can be addressed differently. When detecting the hard-to-understand condition during the ongoing conversation the system can inform both the customer and the agent, because they might not be aware about it. Other implementations include the system notifying only the agent, who might notify customer, the system notifying only the customer, e.g. during IVR call, etc. Letting the customer and/or agent know about the hard-to-understand conditions can help to improve the situation and trigger real time corrective actions.

For explanation purposes, the following hard-to-understand situations can be considered: poor audio transmission quality, e.g., low MOS, language barrier, and/or an agent's ability to understand the customer's issue clearly. A language barrier can include a customer's low language proficiency, gender preference, partial hearing disability, and/or a customer, agent or IVR's low language proficiency, ability to pronounce clearly, proficiency with foreign names, and dialect, e.g. using uncommon expressions. A contact center agents' language proficiency can be taken into consideration, for example through corresponding skill level assignment and incorporation in call routing strategies.

The audio transmission quality, e.g., due to background noise and/or channel noise such as high jitter, packet loss, latency, etc., can be detected (502). Poor audio transmission quality can create stress at the listening party, either consciously or subconsciously, because the brain tries to fill the missing gaps, which can leads to mental exhaustion and negative emotion. The listening party may not even be aware of this because it is happening subconsciously at slight degradation of sound quality which may not be noticeable yet. Poor transmission quality is increasing due to widespread use of radio signals for different purpose, which can cause interference. Similar effects can happen in case of a language barrier.

Language related aspects can be captured and rated, e.g., proficiency, level, dialect, etc., in customer's profile (504). The customer is associated with one or several languages, and when receiving a call from the customer the appropriate language is selected for IVR self-service, and for assisted service the call is routed to an agent with required language skills. There may be still a language-related mismatch, which can have similar results as in case of poor audio transmission.

During a customer's call with the contact center the MOS of the audio connection is determined (506). Parameters for determining the MOS include codec-related impairments, impairments due to the packet loss and delay-related impairments. The parameters can be measured in real time. One or more MOS thresholds can be determined as:

MOS>T1 →OK, no action required;

T1>MOS>T2→degraded but still acceptable, potentially causing stress and negative emotion;

T2>MOS >T3→degraded but as exception acceptable, high probability of causing stress and negative emotion; and

T3>MOS→unacceptable low, immediate corrective action required;

where T1 is about 4.03, T2 is about 3.6 and T3 is about 3.1. Other values can be used. For example, the thresholds can be iteratively adjusted based on actual experiences during contact center operation. Thresholds can be also determined based on the company that provides the service or product, because some companies can tolerate low MOS more than others. For example, the service level, transfer level, escalation level information can be considered, for the particular company and/or as compared to benchmark data for a group of companies. If the company is performing better than peers it may want to have more tolerance, or if performing worse than peers the company may want to have less tolerance.

In case of low MOS values, for example between T1 and T3, there is a risk of customers becoming stressed and dissatisfied with the call because of poor voice quality over the telecommunication system, e.g., regardless of how well the system is communicating with the customer. To mitigate the effects of the poor connections, the customer can be informed about degraded voice quality of line, e.g. through IVR, text message (SMS) or a pop-up on the screen if customer is interacting through web site. In case of assisted service the message can also be shown also to the agent, both for informing about potentially expected customer's dissatisfaction, but also for agent's own benefit who may experience the same stress/dissatisfaction. During assisted service the system can let the agent inform the customer about the poor connection, in addition to or instead of sending a respective message to the customer. Additionally or alternatively, telecommunication lines with low MOS values can be disabled and/or calls dropped if MOS is too low. The MOS value of a given is call can be recorded as part of call metadata, e.g., metadata described with FIG. 2, and can be utilized during post processing.

A similar system logic can be applied when there are language related issues and/or agent helpfulness issues that prevent customers to interact conveniently with the contact center, both with IVR and live agents. In this case real time call recording and analysis can be used to determine potential issues. For example, the customer may ask the agent frequently to repeat something, potentially also asking the agent to say it differently. The agent may also have problems in understanding the customer. The language matching level (LML) can be quantified and captured to be added to the call metadata (508). The LML value can be based on information and measures of language matching and proficiency. The LML and/or MOS values can be used during ongoing live call, for example a warning displayed to agent for either adjustment or suggested/automatic transfer to better matching agent, and during post processing, e.g. when assessing survey results (510).

The system logic can be used to capture details on the customer's language skills and preferences. The information can be used in routing of a customer's future calls, e.g. selecting an agent with customer's preferred dialect, or an agent with very clean/correct/adjusted pronunciation, e.g., pronouncing geographical names in Spanish for customer of Mexican origin, even if the call is in English. The LML information can be used also for contact center planning, e.g. training or hiring agents to better match customers' language specifics.

A technical implementation for MOS can include analyzing real-time transport protocol RTP streams for packet loss and latency, taking the codec into account and calculating the MOS. For LML the real time speech analysis can be integrated in order to measure requests to repeat something, e.g., by customer or agent, misunderstandings, if either party continues conversation in a way that contradicts with what has been actually said, etc. The LML value can be based on a determined scale and used to compose a customer's language profile, which can be taken into account for future call routing and IVR applications selecting. For example, the system can maintain different IVR scripts on the same subject for different customer language profiles, even for a same base language such as English. Other examples include maintaining different IVR scripts with more or less sensitivity to poor voice connection, e.g., based on the actual content (words) and/or intonation (including male/female voice), etc. Interdependencies between MOS and LML can also be considered, e.g., low MOS can cause degraded LML. Additional interdependencies captured as metadata can include call duration, e.g., exhaustion and stress are higher for long duration calls, and whether or not the customer and agent have been informed about detected hard-to-understand condition already during the call. If a customer accepts the invitation for answering to the NPS or other survey, the hard-to-understand condition for the customer's call can be factored. If the given call suffered from poor MOS, long duration, etc. then this can be displayed as additional information to the customer.

Additionally or alternatively, intelligent quality of service (QoS) alerting can be distributed among the contact center systems. The customers can be offered new channels if the dialog is detected as being poor. Agent scripting can be controlled dynamically based on the detection of negative customer experience or if the system detects a compliance risk. The case of dynamic scripting allows speech analytics to trigger new scripting for the agent as the system detects missing context or negative customer sentiment.

Therefore, in one example a customer calls a contact center and when interacting with the IVR 34 the system detects a low MOS of the telecommunication connection. The IVR 34 can prompt the customer to use another phone. When the customer calls back he is connected with a non-native speaking agent. The system detects a language issue, e.g., detects the phrase “I don't understand your English” and suggest or automatically switches the customer to an agent in the U.S. Then a native speaking agent is not qualified to helpfully address the customer's issue, so the customer is transferred to a supervisor. The supervisor understands the customer's issue and is able to help the customer resolve it. The adjustments from one call to the next can occur automatically and/or by the system making suggestions to the customer.

Post call, since the MOS can be correlated with survey results, e.g., NPS results, if the customer gave a poor service rating and there was low MOS then the system can consider the low MOS to be a cause of unfavorable NPS results (512). A result list can be generated, correlated to hard-to-understand scenarios, and acted on based on the low MOS calls, e.g., signifying those calls may be less relevant for determining agent performance, addressing poor connections, calling the customer back to follow up with them, etc. The MOS related issues may not be counted against the contact center agent for agent review purposes.

FIGS. 6-10 are non-limiting examples of elements that can be used to execute the above description. FIG. 6 and FIG. 7 depict block diagrams of an exemplary computing device 600 as may be deployed with the systems and methods described herein. In FIG. 6 and FIG. 7, the computing devices 600 can include a central processing unit 621, and a main memory unit 622. In FIG. 6, a computing device 600 may include a storage device 628, a removable media interface 616, a network interface 618, an input/output (I/O) controller 623, one or more display devices 630c, a keyboard 630a and a pointing device 630b, such as a mouse. The storage device 628 may include, without limitation, storage for an operating system and software. In FIG. 7, the computing devices 600 may also include additional optional elements, such as a memory port 603, a bridge 670, one or more additional input/output devices 630d, 630e and a cache memory 640 in communication with the central processing unit 621. Input/output devices, e.g., 630a, 630b, 630d, and 630e, may be referred to herein using reference numeral 630.

The central processing unit 621 is any logic circuitry that responds to and processes instructions fetched from the main memory unit 622. It may be implemented, for example, in an integrated circuit, in the form of a microprocessor, microcontroller, or graphics processing unit (GPU), or in a field-programmable gate array (FPGA) or application-specific integrated circuit (ASIC). Main memory unit 622 may be one or more memory chips capable of storing data and allowing any storage location to be directly accessed by the central processing unit 621. In the embodiment shown in FIG. 6, the central processing unit 621 communicates with main memory 622 via a system bus 650. FIG. 7 depicts an embodiment of a computing device 600 in which the central processing unit 621 communicates directly with main memory 622 via a memory port 603.

FIG. 7 depicts an embodiment in which the central processing unit 621 communicates directly with cache memory 640 via a secondary bus, sometimes referred to as a backside bus. In other embodiments, the central processing unit 621 communicates with cache memory 640 using the system bus 650. Cache memory 640 typically has a faster response time than main memory 622. In the embodiment shown in FIG. 6, the central processing unit 621 communicates with various I/O devices 630 via a local system bus 650. Various buses may be used as a local system bus 650, including a Video Electronics Standards Association (VESA) Local bus (VLB), an Industry Standard Architecture (ISA) bus, an Extended Industry Standard Architecture (EISA) bus, a MicroChannel Architecture (MCA) bus, a Peripheral Component Interconnect (PCI) bus, a PCI Extended (PCI-X) bus, a PCI-Express bus, or a NuBus. For embodiments in which an I/O device is a display device 630c, the central processing unit 621 may communicate with the display device 630c through an Advanced Graphics Port (AGP). FIG. 7 depicts an embodiment of a computer 600 in which the central processing unit 621 communicates directly with I/O device 630e. FIG. 7 also depicts an embodiment in which local busses and direct communication are mixed: the central processing unit 621 communicates with I/O device 630d using a local system bus 650 while communicating with I/O device 630e directly.

A wide variety of I/O devices 630 may be present in the computing device 600. Input devices include one or more keyboards 630a, mice, trackpads, trackballs, microphones, and drawing tablets. Output devices include video display devices 630c, speakers, and printers. An I/O controller 623, in FIG. 6, may control the I/O devices. The I/O controller may control one or more I/O devices such as a keyboard 630a and a pointing device 630b, e.g., a mouse or optical pen.

Referring again to FIG. 6, the computing device 600 may support one or more removable media interfaces 616, such as a floppy disk drive, a CD-ROM drive, a DVD-ROM drive, tape drives of various formats, a USB port, a Secure Digital or COMPACT FLASH™ memory card port, or any other device suitable for reading data from read-only media, or for reading data from, or writing data to, read-write media. An I/O device 630 may be a bridge between the system bus 650 and a removable media interface 616.

The removable media interface 616 may for example be used for installing software and programs. The computing device 600 may further comprise a storage device 628, such as one or more hard disk drives or hard disk drive arrays, for storing an operating system and other related software, and for storing application software programs. Optionally, a removable media interface 616 may also be used as the storage device. For example, the operating system and the software may be run from a bootable medium, for example, a bootable CD.

In some embodiments, the computing device 600 may comprise or be connected to multiple display devices 630c, which each may be of the same or different type and/or form. As such, any of the I/O devices 630 and/or the I/O controller 623 may comprise any type and/or form of suitable hardware, software, or combination of hardware and software to support, enable or provide for the connection to, and use of, multiple display devices 630c by the computing device 600. For example, the computing device 600 may include any type and/or form of video adapter, video card, driver, and/or library to interface, communicate, connect or otherwise use the display devices 630c. In one embodiment, a video adapter may comprise multiple connectors to interface to multiple display devices 630c. In other embodiments, the computing device 600 may include multiple video adapters, with each video adapter connected to one or more of the display devices 630c. In some embodiments, any portion of the operating system of the computing device 600 may be configured for using multiple display devices 630c. In other embodiments, one or more of the display devices 630c may be provided by one or more other computing devices, connected, for example, to the computing device 600 via a network. These embodiments may include any type of software designed and constructed to use the display device of another computing device as a second display device 630c for the computing device 600. A computing device 600 may be configured to have multiple display devices 630c.

A computing device 600 of the sort depicted in FIG. 6 and FIG. 7 may operate under the control of an operating system, which controls scheduling of tasks and access to system resources. The computing device 600 may be running any operating system, any embedded operating system, any real-time operating system, any open source operating system, any proprietary operating system, any operating systems for mobile computing devices, or any other operating system capable of running on the computing device and performing the operations described herein.

The computing device 600 may be any workstation, desktop computer, laptop or notebook computer, server machine, handheld computer, mobile telephone or other portable telecommunication device, media playing device, gaming system, mobile computing device, or any other type and/or form of computing, telecommunications or media device that is capable of communication and that has sufficient processor power and memory capacity to perform the operations described herein. In some embodiments, the computing device 600 may have different processors, operating systems, and input devices consistent with the device.

In other embodiments the computing device 600 is a mobile device, such as a

Java-enabled cellular telephone or personal digital assistant (PDA), a smart phone, a digital audio player, or a portable media player. In some embodiments, the computing device 600 comprises a combination of devices, such as a mobile phone combined with a digital audio player or portable media player.

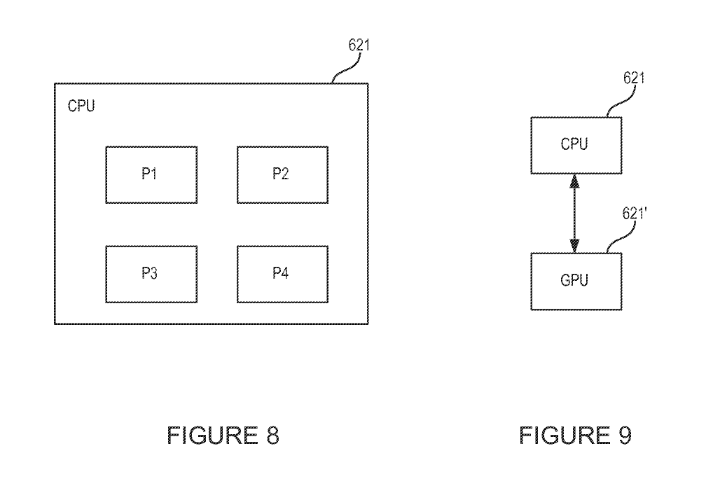

In FIG. 8, the central processing unit 621 may comprise multiple processors P1, P2, P3, P4, and may provide functionality for simultaneous execution of instructions or for simultaneous execution of one instruction on more than one piece of data. In some embodiments, the computing device 600 may comprise a parallel processor with one or more cores. In one of these embodiments, the computing device 600 is a shared memory parallel device, with multiple processors and/or multiple processor cores, accessing all available memory as a single global address space. In another of these embodiments, the computing device 600 is a distributed memory parallel device with multiple processors each accessing local memory only. In still another of these embodiments, the computing device 600 has both some memory which is shared and some memory which may only be accessed by particular processors or subsets of processors. In still even another of these embodiments, the central processing unit 621 comprises a multicore microprocessor, which combines two or more independent processors into a single package, e.g., into a single integrated circuit (IC). In one exemplary embodiment, depicted in FIG. 9, the computing device 600 includes at least one central processing unit 621 and at least one graphics processing unit 621′.

In some embodiments, a central processing unit 621 provides single instruction, multiple data (SIMD) functionality, e.g., execution of a single instruction simultaneously on multiple pieces of data. In other embodiments, several processors in the central processing unit 621 may provide functionality for execution of multiple instructions simultaneously on multiple pieces of data (MIMD). In still other embodiments, the central processing unit 621 may use any combination of SIMD and MIMD cores in a single device.

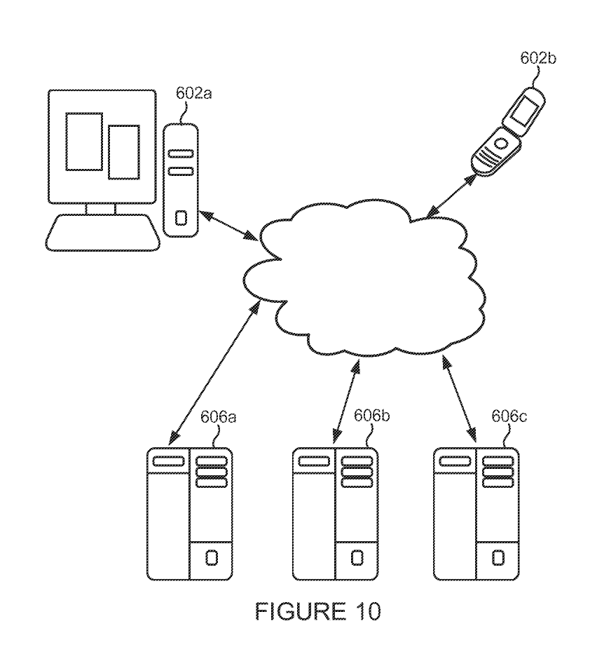

A computing device may be one of a plurality of machines connected by a network, or it may comprise a plurality of machines so connected. FIG. 10 shows an exemplary network environment. The network environment comprises one or more local machines 602a, 602b (also generally referred to as local machine(s) 602, client(s) 602, client node(s) 602, client machine(s) 602, client computer(s) 602, client device(s) 602, endpoint(s) 602, or endpoint node(s) 602) in communication with one or more remote machines 606a, 606b, 606c (also generally referred to as server machine(s) 606 or remote machine(s) 606) via one or more networks 604. In some embodiments, a local machine 602 has the capacity to function as both a client node seeking access to resources provided by a server machine and as a server machine providing access to hosted resources for other clients 602a, 602b. Although only two clients 602 and three server machines 606 are illustrated in FIG. 10, there may, in general, be an arbitrary number of each. The network 604 may be a local-area network (LAN), e.g., a private network such as a company Intranet, a metropolitan area network (MAN), or a wide area network (WAN), such as the Internet, or another public network, or a combination thereof.

The computing device 600 may include a network interface 618 to interface to the network 604 through a variety of connections including, but not limited to, standard telephone lines, local-area network (LAN), or wide area network (WAN) links, broadband connections, wireless connections, or a combination of any or all of the above. Connections may be established using a variety of communication protocols. In one embodiment, the computing device 600 communicates with other computing devices 600 via any type and/or form of gateway or tunneling protocol such as Secure Socket Layer (SSL) or Transport Layer Security (TLS). The network interface 618 may comprise a built-in network adapter, such as a network interface card, suitable for interfacing the computing device 600 to any type of network capable of communication and performing the operations described herein. An I/O device 630 may be a bridge between the system bus 650 and an external communication bus.

The systems and methods described above may be implemented in many different ways in many different combinations of hardware, software firmware, or any combination thereof. In one example, the systems and methods can be implemented with a processor and a memory, where the memory stores instructions, which when executed by the processor, causes the processor to perform the systems and methods. The processor may mean any type of circuit such as, but not limited to, a microprocessor, a microcontroller, a graphics processor, a digital signal processor, or another processor. The processor may also be implemented with discrete logic or components, or a combination of other types of analog or digital circuitry, combined on a single integrated circuit or distributed among multiple integrated circuits. All or part of the logic described above may be implemented as instructions for execution by the processor, controller, or other processing device and may be stored in a tangible or non-transitory machine-readable or computer-readable medium such as flash memory, random access memory (RAM) or read only memory (ROM), erasable programmable read only memory (EPROM) or other machine-readable medium such as a compact disc read only memory (CDROM), or magnetic or optical disk. A product, such as a computer program product, may include a storage medium and computer readable instructions stored on the medium, which when executed in an endpoint, computer system, or other device, cause the device to perform operations according to any of the description above. The memory can be implemented with one or more hard drives, and/or one or more drives that handle removable media, such as diskettes, compact disks (CDs), digital video disks (DVDs), flash memory keys, and other removable media.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

While various embodiments have been described, it can be apparent that many more embodiments and implementations are possible. Accordingly, the embodiments are not to be restricted.

1-20. (canceled)

21. A system for managing communications of a contact center, the system comprising:
a switch configured to receive a plurality of communications for routing to one or more resources of the contact center;
a processor coupled to the switch; and
a memory coupled to the processor, wherein the memory stores instructions that, when executed by the processor, cause the processor to:
monitor a first communication corresponding to an interaction between an agent and a customer;
detect a communication error of the first communication; and
in response to detecting the communication error, transmit a signal to the switch for establishing connection of a second communication corresponding to the interaction.

22. The system of claim 21, wherein the instructions further cause the processor to transmit the signal to the switch in real time during the first communication.

23. The system of claim 21, wherein the instructions further cause the processor to transmit a message to an electronic device associated with the customer to notify the customer of the communication error.

24. The system of claim 21, wherein the communication error comprises a miscommunication between the agent and the customer.

25. The system of claim 21, wherein the communication error comprises a data transmission error.

26. The system of claim 21, wherein the first communication comprises a voice communication.

27. The system of claim 26, wherein the second communication comprises a text communication.

28. The system of claim 26, wherein the second communication comprises a video communication.

29. The system of claim 21, wherein the communication error comprises a background noise.

30. The system of claim 21, wherein the communication error comprises a repeat request.

31. A method for managing communications of a contact center, the method comprising:
monitor, by a processor, a first communication corresponding to an interaction between an agent and a customer;
detecting, by the processor, a communication error of the first communication; and
in response to detecting the communication error, transmitting, by the processor, a signal to a switch for establishing connection of a second communication corresponding to the interaction.

32. The method of claim 31, further comprising transmitting, by the processor, the signal to the switch in real time during the first communication.

33. The method of claim 31, further comprising transmitting, by the processor, a message to an electronic device associated with the customer to notify the customer of the communication error.

34. The method of claim 31, wherein the communication error comprises a miscommunication between the agent and the customer.

35. The method of claim 31, wherein the communication error comprises a data transmission error.

36. The method of claim 31, wherein the first communication comprises a voice communication.

37. The method of claim 36, wherein the second communication comprises a text communication.

38. The method of claim 36, wherein the second communication comprises a video communication.

39. The method of claim 31, wherein the communication error comprises a background noise.

40. The method of claim 31, wherein the communication error comprises a repeat request.
